(19) United States
(12) Patent Application Publication
(10) Pub. No.: US 2011/0114693 A1
(43) Pub. Date: May 19, 2011

(54) BUTTON PLIERS WITH IMPROVED RETAINING SEATS

(76) Inventor: Li-Chieh Lin, Changhua City (TW)

(21) Appl. No.: 12/620,609

(22) Filed: Nov. 18, 2009

(51) Int. Cl. A41H 37/04; B25B 7/02

(52) U.S. Cl. 227/15; 227/144; 81/418

(57) ABSTRACT

A pair of button pliers with improved retaining seats is disclosed. When the jaw members of the pliers are brought together with retaining seats carrying a male button element and a female button element retained thereon, respectively, the retaining seats help the male button element and the female button element to firmly combine as a whole button.

### BACKGROUND OF THE INVENTION

1. Technical Field

The present invention relates to pliers for fastening a male element and a female element of a button on a piece of cloth. More particularly, the disclosed pair of button pliers is configured to hold the male and female elements with improved retaining seats and snap them together.

2. Description of Related Art

A pair of conventional button pliers as shown in FIG. 1 and FIG. 2 typically has its jaw members provided with a first retaining seat 6 and a second retaining seat 7. The first retaining seat 6 includes a first pressing segment 61 while the second retaining seat 7 includes a second pressing segment 71. The first pressing segment 61 has a central concave surface and the second pressing segment 71 includes a circular concave portion 711 that provides the second pressing segment 71 with a centripetally inclined surface. Thereby, when a male element 41 and a female element 42 of a button are placed in the first pressing segment 61 and the second pressing segment 71, respectively, an operator can squeeze the pliers and thus snap the male and female elements 41, 42 to fabricate the button. However, as shown in FIG. 2, due to the central concave surface of the first pressing segment 61, the male button element 41 only contacts a small area of the first pressing segment 61, but not fits close with the first pressing segment 61. Furthermore, due to the circular concave portion 711 of the second pressing segment 71, the centripetally inclined surface only allows the second pressing segment 71 to contact a periphery of a fixing socket 421 of the female button element 42, and hinders the female button element 42 from fitting close with the second pressing segment 71, causing an interval 72 between the female button element 42 and the second pressing segment 71, as shown in FIG. 3 and FIG. 4. As a result of the above fitting problems, when fixing pins 411 of the male button element 41 come into contact with the fixing socket 421 of the female button element 42, impact therebetween may possibly happen, and when the fixing pins 411 lodge in the fixing socket 421, both the fixing pins 411 and the fixing socket 421 receive insufficient supporting force, causing the fixing pins 411 unable to fully enter the fixing socket 421, as shown in FIG. 5, rendering unsecured combination of the resultant button.

### SUMMARY OF THE INVENTION

In view of the shortcomings of the prior art device, the present invention provides a pair of button pliers with improved retaining seats. The pair of pliers has two jaw members provided with a first retaining seat and a second retaining seat, respectively. Therein, the first retaining seat includes a first coupling segment and a first pressing segment. The first coupling segment is connected with one said jaw member of the pliers and the first pressing segment has a circular groove for fittingly receiving a male button element. The second retaining seat has a second coupling segment and a second pressing segment. The second coupling segment is connected with thither jaw member of the pliers, and the second pressing segment has a circular block for supporting a female button element. Thereby, when the jaw members of the pliers are squeezed, the first retaining seat and the second retaining seat come close to each other, so that the circular groove and the circular block of the pressing segments make the male and female elements combine into a whole button.

The primary objective of the present invention is to provide the forgoing button pliers, wherein the circular groove and the circular block facilitate increasing contacting areas between the male button element and the first pressing segment , and between the female button element and the second pressing segment , so that the male and female elements are allowed to fit close with the first pressing segment and the second pressing segment , thereby the male and female elements can be firmly combined when the first retaining seat and the second retaining seat are brought to each other.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 is a perspective view of a pair of conventional button pliers;

FIG. 2 is a schematic drawing showing the conventional button pliers holding a male element and a female element of a button;

FIGS. 3 and 4 are schematic drawings illustrating operation of the conventional button pliers;

FIG. 5 is a schematic drawing depicting the male and female elements of FIG. 4 assembled;

FIG. 6 is an exploded view of a pair of button pliers disclosed in the present invention;

FIG. 7 is a perspective view of the button pliers of the present invention;

FIG. 8 is a schematic drawing showing the button pliers of the present invention holding a male element and a female element of a button;

FIGS. 9 and 10 are schematic drawings illustrating operation of the button pliers of the present invention; and

FIG. 11 is a schematic drawing depicting the male and female elements of FIG. 10 assembled.

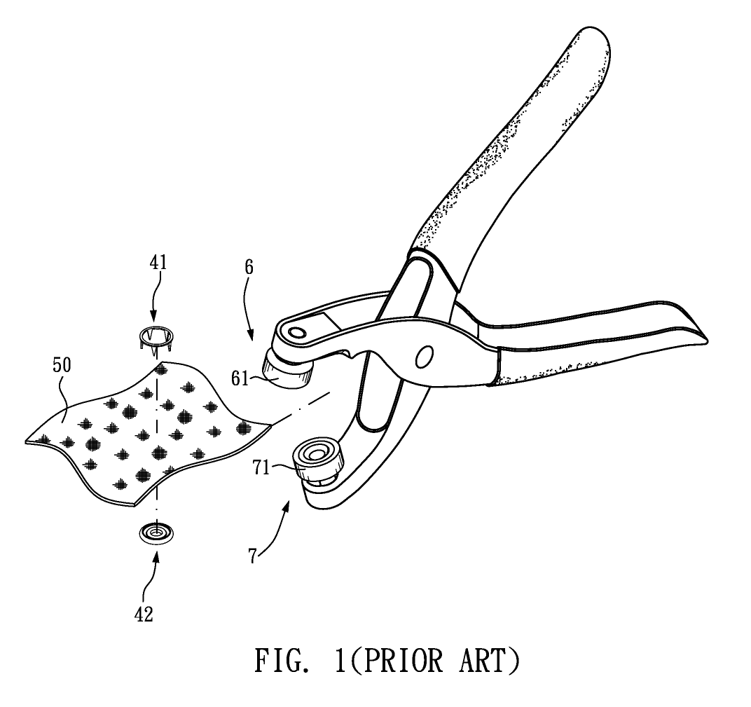

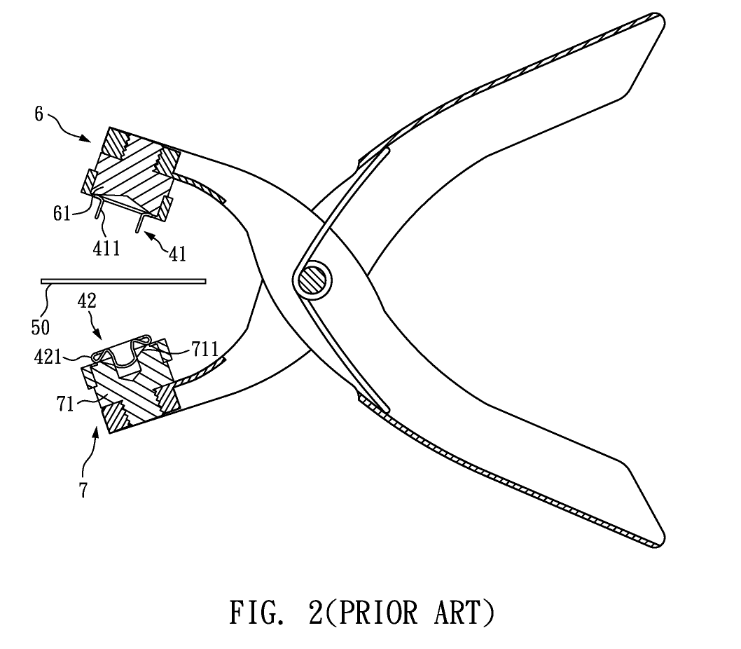

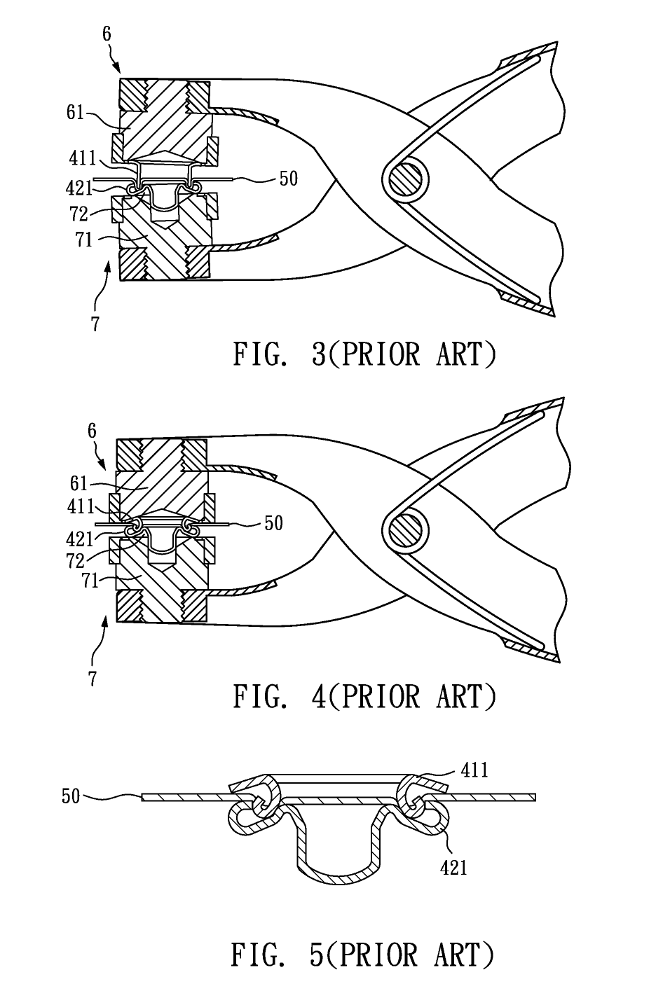

### DETAILED DESCRIPTION OF THE PREFERRED EMBODIMENT

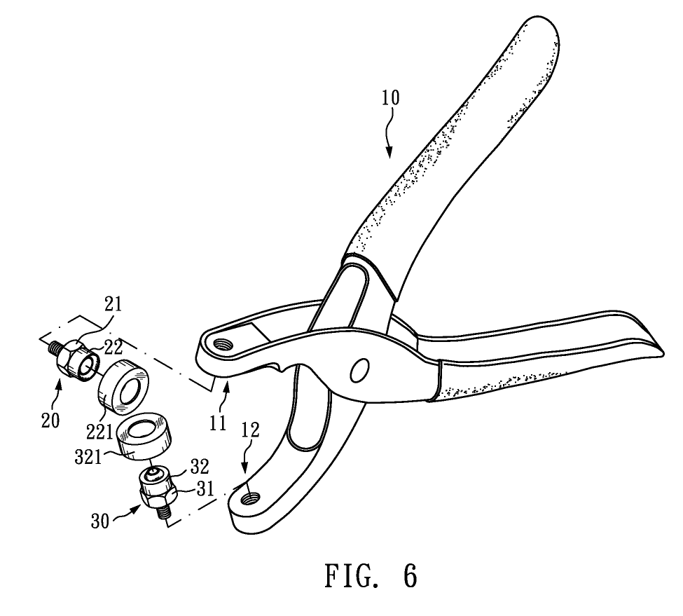

Referring to FIG. 6, the present invention provides a pair of button pliers with improved retaining seats. The pair of button pliers 10 is equipped with the retaining seats, namely a first retaining seat 20 and a second retaining seat 30.

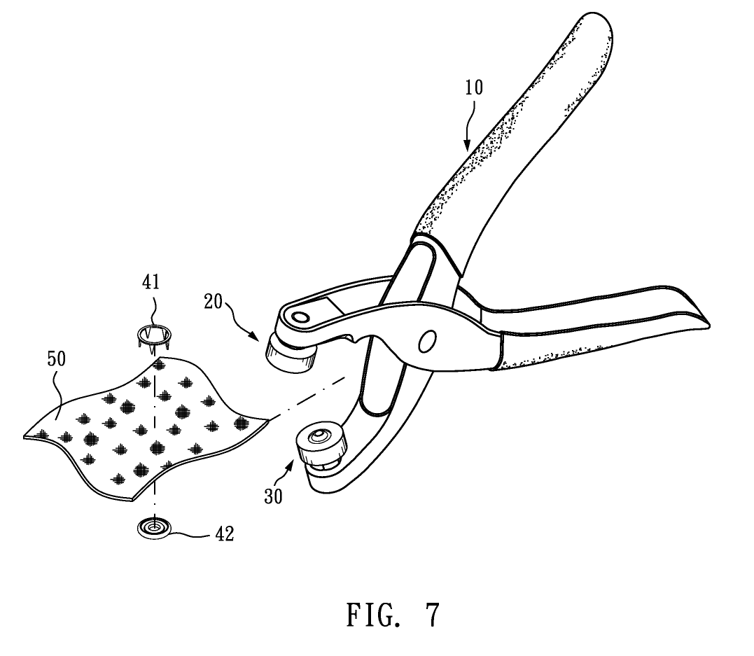

As shown in FIG. 6 and FIG. 7, the pliers 10 has a first jaw member 11 and a second jaw member 12, which are provided with the first retaining seat 20 and the second retaining seat 30, respectively. The first retaining seat 20 includes a first coupling segment 21 and a first pressing segment 22. Therein, the first coupling segment 21 is screwedly coupled with the first jaw member 11 of the pliers 10, while the first pressing segment 22 extends from the first coupling segment 21 toward the first jaw member 11. The second retaining seat 30 includes a second coupling segment 31 and a second pressing segment 32. Therein, the second coupling segment 31 is screwedly coupled with the second jaw member 12 of the pliers 10, while the second pressing segment 32 extends from the second coupling segment 31 toward the second jaw member 12. Furthermore, the first pressing segment 22 and the second pressing segment 32 are sleeved by elastic pads 221, 321, respectively. The elastic _{.}pads 221, 321 serve to not only position a male element 41 and a female element 42 of a button for preventing the first pressing segment 22 and the second pressing segment 32 from coming off, but also act as buffers when the first retaining seat 20 and the second retaining seat 30 are snapped together for preventing the first retaining seat 20 and the second retaining seat 30 from mutual impact or attrition.

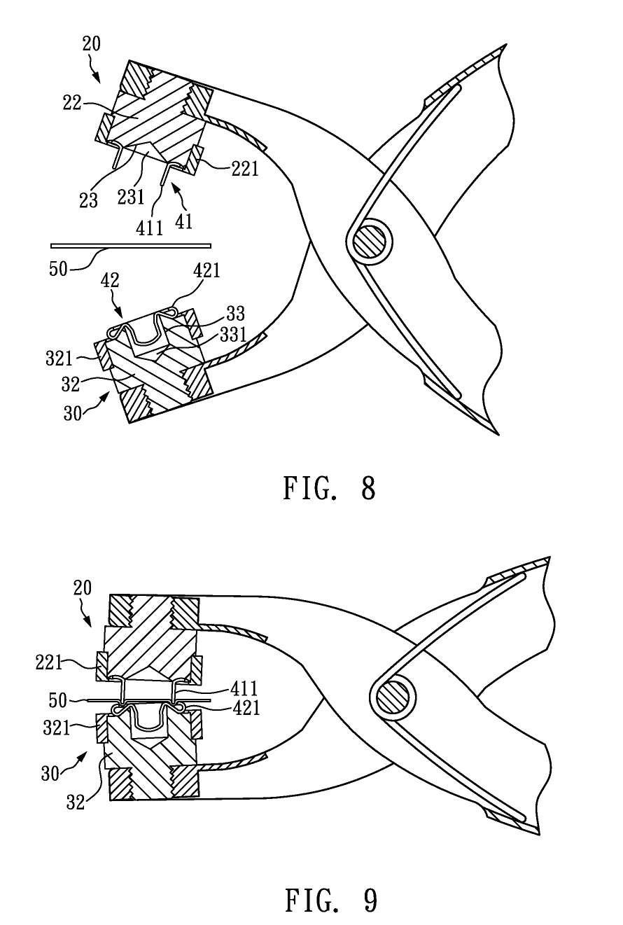

Referring to FIG. 8, the first pressing segment 22 includes a, whose inner diameter is sized to fittingly match an inner diameter of the male button element so that the circular groove 23 can fitly receive the male button element 41. In addition, the circular groove 23 circles an accommodating space 231.

The second pressing segment 32 has a circular block 33 for being received in the accommodating space 231 and serving to position a female button element 42. The circular block 33 has a circular convex surface and a recess 331 extending along an axis of the second coupling segment 31 so as to match the contour of the female button element 42.

Particularly, the circular convex surface of the circular block 23 contacting the female button element 42 may be a circular portion having a top surface in the shape of flat inclined plane, concave inclined plane, or convex inclined plane. The circular block 23 in another shape may be used as long as it provides the circular convex surface to close fit the female button element 42.

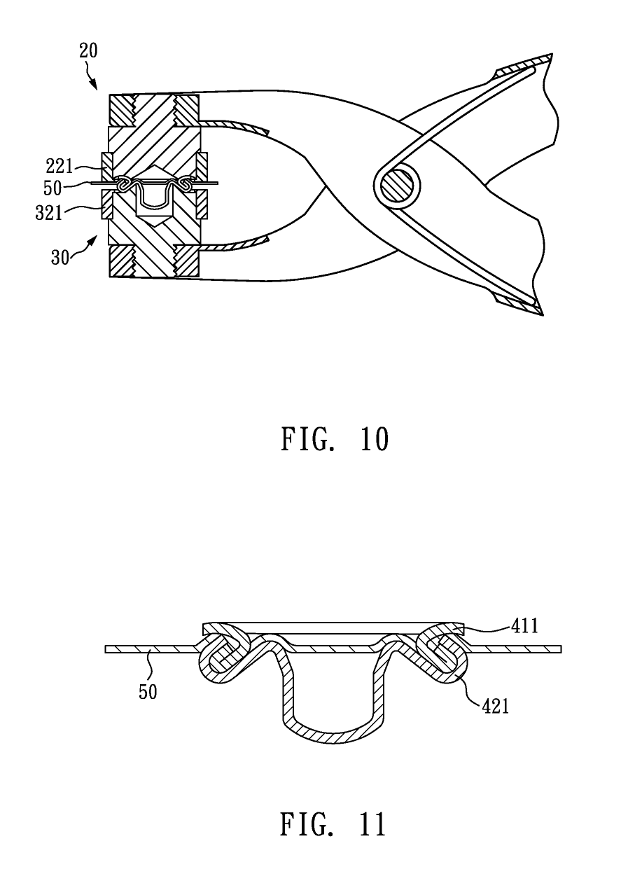

In this embodiment, as shown in FIG. 8 and FIG. 9, a piece of cloth 50 on which the button is to be installed is placed between the first retaining seat 20 and the second retaining seat 30. Then, when the first retaining seat 20 and the second retaining seat 30 are brought together, the first pressing segment 22 and the male button element 41 contact right at a position corresponding to where an arc of the circular groove 23 is formed so that the male button element 41 is allowed to fit close with the first pressing segment 22. Meantime, the second pressing segment 32 and the female button element 42 are such contacting the a inclined surface of the fixing socket 421 close abuts upon the circular block 33 so that the female button element 42 fits close with the second pressing segment 32. Thereby, owing to the support from the circular groove 23 and the circular block 33 of the first and second pressing segments 22, 32, when piercing through the cloth 50 and contacting the fixing socket 421 of the female button element 42, the fixing pins 411 of the male button element 41 are forced to curl along a profile of the fixing socket 421, thereby causing the male and female elements 41, 42 combined as a whole piece, as shown in FIG. 10 and FIG. 11.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A pair of button pliers with improved retaining seats, the button pliers comprising:
a first jaw member connected with one said retaining seats, or a first retaining seat;
a second jaw member connected with the other said retaining seats, or a second retaining seat;
the first retaining seat having a first coupling segment and a first pressing segment, wherein the first pressing segment includes a circular groove;
the second retaining seat having a second coupling segment and a second pressing segment, wherein the second pressing segment includes a circular block;
whereby, when the jaw members of the pliers are brought together with a male button element retained in the circular groove of the first retaining seat and with a button female retained by the circular block of the second retaining seat, the circular groove of the first retaining seat and the circular block of the second retaining seat jointly help the male button element and the female button element to combine as a whole button.

2. The button pliers of claim 1, wherein the circular groove circles an accommodating space for receiving the circular block.

3. The button pliers of claim 1, wherein an inner diameter of the circular groove is sized to fittingly match an inner diameter of the male button element.

4. The button pliers of claim 1, wherein the first coupling segment is screwedly coupled with the first jaw member of the button pliers.

5. The button pliers of claim 1, wherein the circular block has a circular convex surface so as to match a contour of the female button element.

6. The button pliers of claim 5, wherein the circular convex surface of the circular block contacting the female button element is a circular portion having a top surface in the shape of a flat inclined plane, a concave inclined plane, or a convex inclined plane.

7. The button pliers of claim 1, wherein the second coupling segment is screwedly coupled with the second jaw member of the button pliers.

8. The button pliers of claim 1, wherein the circular block has a recess extending along an axis of the second coupling segment.

9. The button pliers of claim 1, wherein each of the first pressing segment and the second pressing segment is sleeved by an elastic pad.
